(19) United States
(12) Patent Application Publication
(10) Pub. No.: US 2006/0228534 A1
(43) Pub. Date: Oct. 12, 2006

(54) Method for reduction of islanding in metal layers formed on dielectric materials

(75) Inventors: Kenneth Scott Weil, Richland, WA (US); Eric S. Mast, Richland, WA (US); Vincent L. Sprenkle, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, Richland, WA (US)

(21) Appl. No.: 11/102,508

(22) Filed: Apr. 8, 2005

(51) Int. Cl. B32B 3/00; B32B 7/00

(52) U.S. Cl. 428/210; 428/209

(57) ABSTRACT

Islanding in metal layers on a dielectric material can be reduced by using a wetting agent between the metal layer and the dielectric material. One embodiment of the present invention encompasses a method comprising the steps of depositing a ceria layer on the dielectric material and depositing the metal layer on the ceria layer, wherein the ceria layer is the wetting agent for the metal layer. Another embodiment encompasses a multi-layer ceramic capacitor comprising a repeat layer having a base metal electrode formed on a ceria layer, which is deposited on a dielectric layer.

### SUMMARY

Islanding of metal layers on dielectric materials can be reduced by using ceria as a wetting agent for the metal layer. Accordingly, one embodiment of the present invention is a method for reducing islanding in metal layers on a dielectric material comprising the steps of depositing a ceria layer on the dielectric material and depositing the metal layer. The ceria layer and the metal layers can be substantially separate layers, or they can be interdipersed in substantially one combined layer. The method can use a deposition technique including, but not limited to, screen printing, spray deposition, chemical vapor deposition (CVD), sputtering, tape casting, spin coating, physical deposition, and combinations thereof.

Another embodiment of the present invention encompasses a method for reducing electrode islanding in multi-layer ceramic capacitors (MLCC). Such a method comprises the step of depositing a layer of ceria between the dielectric layer and the base metal electrode in a repeat layer of the MLCC. The ceria layer and the metal layers can be substantially separate layers, or they can be interdipersed in substantially one combined layer. The deposition can be achieved using a deposition technique including, but not limited to, screen printing, spray deposition, CVD, sputtering, tape casting, spin coating, physical deposition, and combinations thereof.

Yet another embodiment of the present invention encompasses a multi-layer ceramic capacitor comprising a repeat layer comprising a dielectric layer, a ceria layer, and a base metal electrode, wherein the ceria layer comprises a wetting agent and can be deposited between the dielectric layer and the base metal electrode. Alternatively, the ceria wetting agent can be interdispersed with the metal, which metal composes the metal electrode.

### DESCRIPTION OF DRAWINGS

Embodiments of the invention are described below with reference to the following accompanying drawings.

FIGS. 1(a) and (b) are schematic representations of a multi-layer ceramic capacitor.

FIG. 2 shows scanning electron micrographs of Ni on BaTiO₃ (a) with the ceria wetting agent and (b) without the ceria wetting agent.

### DETAILED DESCRIPTION

As used herein, ceria can refer to a material having a composition of CeO_{2-δ}, wherein δ is approximately between −0.5 and 0.15. Slight deviations from the stoichiometric Ce:O ratio of 1:2 can be the result of processing conditions, which can leave a nominally CeO₂ film slightly oxygen rich or oxygen deficient. For example, heating a CeO₂ film in a reducing atmosphere, such as H₂, can result in slight oxygen deficiency. Alternatively, the use of excessive and/or energetic oxygen during processing can result in the incorporation of oxygen in interstitial sites, thereby resulting in a slightly oxygen-rich material.

The ceria can be deposited on the dielectric material by techniques including, but not limited to, screen printing, spray deposition, CVD, sputtering, tape casting, spin coating, physical deposition, and combinations thereof. Precursors for use in these deposition techniques can include, but are not limited to, cerium-based organometallic compounds, cerium- and/or ceria-based slurries, cerium- and/or ceria-based solutions, and combinations thereof.

The degree of islanding in a metal layer deposited on a dielectric can be a function of processing parameters, which parameters can include, but are not limited to, the average and/or peak temperature during processing, the presence and duration of a heat treatment step, the thickness of the metal layer, and the compositions of the metallization layer and the underlying ceramic dielectric. For example, nickel metal layers deposited on BaTiO₃ dielectrics can break up and form discontinuities during high-temperature heat treatments at conditions that are often required for subsequent material or device processing. The result can be islanding in the nickel film, which can be characterized by portions of the metallization layer not being in electrical contact with the rest of the layer, leading to degradation in the performance of devices that benefit from continuous metal layers. In the material system of the present example, Ni layers that are less than approximately 2 microns commonly appear to be susceptible to islanding. Thinner Ni layers can exhibit islanding after relatively mild heat treatments and thicker layers can tend to be more robust. Thus, Ni layers that are relatively thin and/or are subjected to high-temperatures can require thicker ceria layers to prevent islanding of the metal layer.

According to embodiments of the present invention, application of a ceria layer between the dielectric layer and the metal layer can reduce islanding of the metal layer by acting as a wetting agent. In one embodiment, the thickness of the ceria layer is between approximately 0.02 micron and approximately 0.4 micron. However, the specification of a ceria-layer thickness is not meant to be limiting since the thickness required to reduce islanding of the metal layer can depend on the processing parameters, as described above.

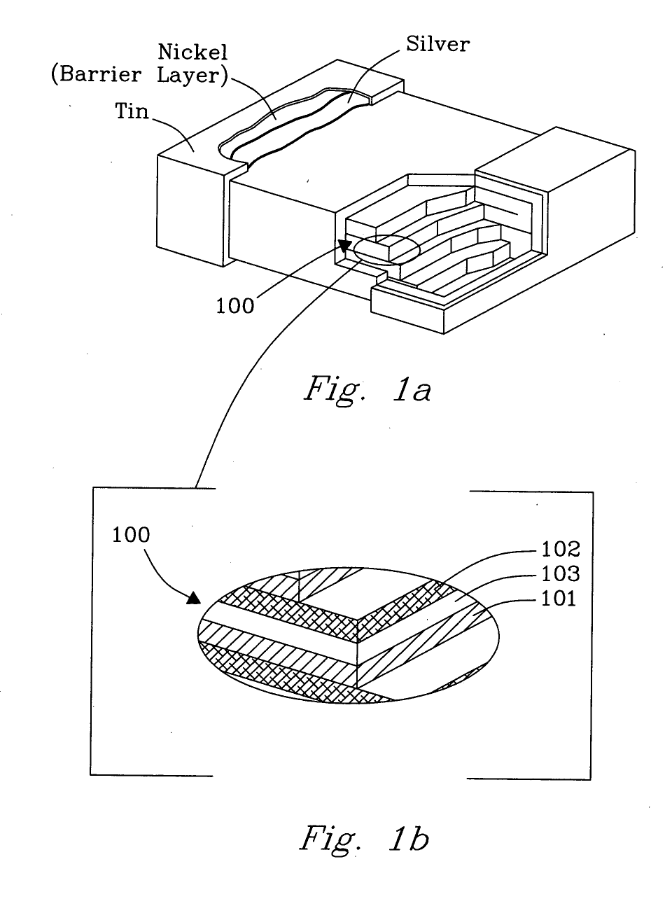

The dielectric material can be embodied by dielectric substrates and/or dielectric films. With respect to dielectric films, the thickness of the dielectric material can range from approximately 0.2 micron to approximately 20 microns. Deposition of the dielectric can utilize techniques including, but not limited to, screen printing, spray deposition, CVD, sputtering, tape casting, spin coating, physical deposition, and combinations thereof. Selection of the particular composition of the material, and therefore, the bandgap and/or dielectric constant, will depend on the intended application. Referring to FIGS. 1(a) and 1(b), one example of such an application includes, but is not limited to, multi-layer ceramic capacitors (MLCC), wherein a repeat layer 100 comprises a base metal electrode 102 formed on a thin layer of ceria 103, which is deposited on a dielectric layer 101. The range of appropriate dielectric constants (εᵣ) for the dielectric layer 101 can range from approximately 200 to approximately 10,000.

Regardless of the application, examples of dielectric materials include, but are not limited to, barium titanates, various doped titanates, alumina, aluminum nitride, aluminum silicate, sillimanite, barium neodymium titanate, barium strontium titanate (BST), barium tantalate, beryllia, boron nitride, calcium titanate, calcium copper titanate (CCT), calcium magnesium titanate (CMT), glass ceramic, cordierite/magnesium aluminum silicate, forsterite/magnesium silicate, lead magnesium niobate (PMN), lead zinc niobate (PZN), lithium niobate (LN), magnesium silicate, magnesium titanate, niobate or niobium oxide, porcelain, quartz, sapphire, strontium titanate, silica, silicate, steatite, tantalite, tantalum oxide, titania, titanate, zircon, zirconia, zirconate, zirconium tin titanate and combinations thereof.

The metal layer can comprise materials including, but not limited to, Ni, Ni alloys, Cu, Cu alloys, Ag, Ag—Pd alloys, Au, Au alloys, and combinations thereof. The metal layer can be deposited using a deposition technique including, but not limited to, screen printing, CVD, or a combination thereof. In the MLCC embodiment described above, the metal layer can comprise a base metal electrode 102 having a thickness greater than approximately 0.1 micron or less than approximately 2 microns. In another embodiment, the ceria layer and the metal layer can be interdispersed to form a substantially combined ceria wetting agent/metal electrode layer.

Example: Ceria Wetting Agent for Nickel on Barium Titanate

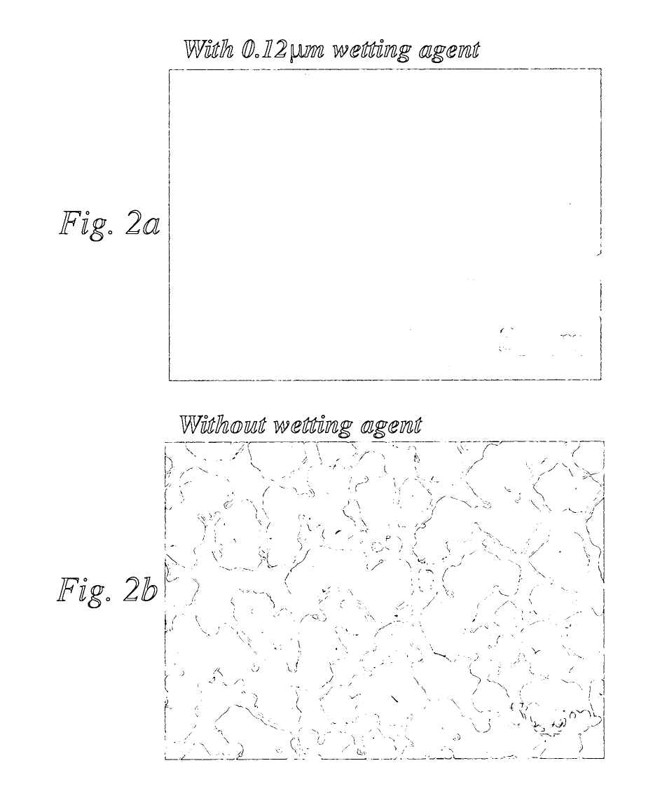

In one embodiment, thin films (0.1-0.5 μm) of CeO_{2-δ}were deposited on dense BaTiO₃ substrates via radio-frequency (RF) sputtering. The CeO_{2-δ} was then diffused into the substrate during a high temperature anneal of 1000-1300° C. in an oxidizing environment. After the high temperature anneal, Ni metal was direct-current (DC) sputtered unto the substrate with a thickness range of 0.5-2.0 mm. Samples with the sputtered Ni were then taken to approximately 1300-1350° C. for 2-4 hrs in a reducing environment (e.g., Ar having 2.75% H₂, or 1% H₂ in N₂ with a dew point of 25° C.) SEM micrographs were used to determine the effect of ceria wetting layer on the Ni islanding phenomena. Referring to FIGS. 2(a) and (b), a 0.8 micron thick layer of Ni was deposited on BaTiO₃ with and without the ceria wetting layer, respectively, and subsequently heat treated as described above. The sample having the ceria wetting agent shows a continuous Ni overlayer, while the sample without ceria shows islanding of the Ni.

In a second embodiment, Ni metal powder containing the ceria wetting agent was prepared and sintered with tape cast layers of BaTiO3. The Ni-Ceria powder was initially prepared as an NiO-ceria composite via the Glycine-nitrate method. Details regarding the Glycine-nitrate method are described in U.S. Pat. No. 5,705,132 and are hereby incorporated by reference. Upon reduction at 500° C. for 4 hrs in a 4% H2/Ar atmosphere a fine Ni powder was formed interdispersed with submicron Ceria particles. The resulting powder was then three-roll milled into a paste form by addition of ˜40 wt % Ferro A249-19-15 vehicle system. The prepared paste was then screen-printed onto thin (˜10 mm) BaTiO₃ tapes supported on a Mylar carrier film. The BaTiO₃ tapes were prepared with 17% solids loading of 0.5 μm d₅₀ BaTiO₃ powder (Praxair Specialty Ceramics) dispersed in a MEK/Ethanol solvent system. Polyvinyl-butyl (PVB) binder was added along with a butyl-benzene phthalate (BBP) plasticizer after dispersion of the powder. Tape casting was done using a 1 mil opening on the doctor blade to give a 10 μm thick tape upon drying. After screen printing the Ni-Ceria paste on the BaTiO3 tapes, multiple layers were laminated together between 80-110° C. using a Cheminstruments Roll-Laminator. Multilayer samples were the co-fired at 0.5° C./min to 300-450° C. and held for 4 hrs in oxidizing atmospheres to enable binder burnout. Sintering took place in a reducing atmosphere with at a ramp rate of 3° C./min to the sintering temperature of 1200-1350° C. followed by a 4 hr hold.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A method for reducing islanding in metal layers on a dielectric material comprising the steps of:
a. Depositing a ceria layer on the dielectric material; and
b. Depositing the metal layer, wherein the ceria layer is a wetting agent for the metal layer.

2. The method as recited in claim 1, wherein the depositing steps comprise using a deposition technique selected from the group consisting of screen printing, spray deposition, CVD, sputtering, tape casting, spin coating, physical deposition, and combinations thereof.

3. The method as recited in claim 1, wherein the ceria layer is between approximately 0.02 micron and approximately 0.4 micron.

4. The method as recited in claim 1, wherein the dielectric material is selected from the group consisting of barium titanates, various doped titanates, alumina, aluminum nitride, aluminum silicate, sillimanite, barium neodymium titanate, barium strontium titanate (BST), barium tantalate, beryllia, boron nitride, calcium titanate, calcium copper titanate (CCT), calcium magnesium titanate (CMT), glass ceramic, cordierite/magnesium aluminum silicate, forsterite/magnesium silicate, lead magnesium niobate (PMN), lead zinc niobate (PZN), lithium niobate (LN), magnesium silicate, magnesium titanate, niobate or niobium oxide, porcelain, quartz, sapphire, strontium titanate, silica, silicate, steatite, tantalite, tantalum oxide, titania, titanate, zircon, zirconia, zirconate, zirconium tin titanate and combinations thereof.

5. The method as recited in claim 1, wherein the dielectric material comprises a layer having a thickness between approximately 0.2 micron and approximately 20 microns

6. The method as recited in claim 1, wherein the metal layer comprises a material selected from the group consisting of Ni, Ni alloys, Cu, Cu alloys, Ag, Ag—Pd alloys, Au, Au alloys, and combinations thereof.

7. The method as recited in claim 1, wherein the metal layer and the ceria layer are interdispersed to form substantially one layer.

8. A method for reducing electrode islanding in multi-layer ceramic capacitors (MLCC) comprising the step of depositing a layer of ceria between the dielectric layer and the base metal electrode in a repeat layer of the MLCC.

9. The method as recited in claim 8, wherein the depositing comprises using a deposition technique selected from the group consisting of screen printing, spray deposition, CVD, sputtering, tape casting, spin coating, or physical deposition, and combinations thereof.

10. The method as recited in claim 8, wherein the base metal electrode and the ceria layer are interdispersed to form substantially one layer.

11. The method as recited in claim 8, wherein the ceria layer is between approximately 0.02 micron and approximately 0.4 micron.

12. The method as recited in claim 8, wherein the deposition technique utilizes a cerium-based precursor, a cerium- and/or ceria-based slurry, a cerium- and/or cerium-based solution, or a combination thereof.

13. The method as recited in claim 8, wherein the dielectric constant (εᵣ) of the dielectric layer ranges from approximately 200 to approximately 10,000.

14. The method as recited in claim 8, wherein the dielectric layer is selected from the group consisting of barium titanate and various doped titanates and barium titanates, alumina, aluminum nitride, aluminum silicate, sillimanite, barium neodymium titanate, barium strontium titanate (BST), barium tantalate, beryllia, boron nitride, calcium titanate, calcium copper titanate (CCT), calcium magnesium titanate (CMT), glass ceramic, cordierite/magnesium aluminum silicate, forsterite/magnesium silicate, lead magnesium niobate (PMN), lead zinc niobate (PZN), lithium niobate (LN), magnesium silicate, magnesium titanate, niobate or niobium oxide, porcelain, quartz, sapphire, strontium titanate, silica, silicate, steatite, tantalite, tantalum oxide, titania, titanate, zircon, zirconia, zirconate, zirconium tin titanate and combinations thereof.

15. The method as recited in claim 8, wherein the dielectric layer thickness is between approximately 0.2 micron and approximately 20 microns

16. The method as recited in claim 8, wherein the base metal electrode layer comprises a material selected from the group consisting of Ni, Ni alloys, Cu, Cu alloys, Ag, Ag—Pd alloys, Au, Au alloys, and combinations thereof.

17. A multi-layer ceramic capacitor (MLCC) comprising a repeat layer comprising a dielectric layer, a ceria layer, and a base metal electrode, wherein the ceria layer comprises a wetting agent and is deposited between the dielectric layer and the base metal electrode.

18. The MLCC as recited in claim 17, wherein the ceria layer is between approximately 0.02 micron and approximately 0.4 micron.

19. The MLCC as recited in claim 17, wherein the base metal electrode is greater than approximately 0.1 micron.

20. The MLCC as recited in claim 17, wherein the base metal electrode is less than approximately 2 microns.

21. The method as recited in claim 17, wherein the base metal electrode and the ceria layer are interdispersed to form substantially one layer.
